(19) United States
(12) Patent Application Publication
(10) Pub. No.: US 2007/0299670 A1
(43) Pub. Date: Dec. 27, 2007

(54) Biometric and speech recognition system and method

(75) Inventor: Hisao M. Chang, Cedar Park, TX (US)

Correspondence Address: TOLER SCHAFFER, LLP, 8500 BLUFFSTONE COVE, SUITE A201, AUSTIN, TX, 78759, US

(73) Assignee: SBC Knowledge Ventures, LP, Reno, NV (US)

(21) Appl. No.: 11/475,551

(22) Filed: Jun. 27, 2006

(51) Int. Cl. G10L 21/00

(52) U.S. Cl. 704/275

(57) ABSTRACT

A biometric and speech recognition system and method is disclosed. In a particular embodiment, the system includes a remote control device having a non-voice based biometric detector and a speech recognition engine. User profile data may be stored in a memory device of the remote control device. The system may also include a distributed speech recognition engine. Spoken commands may be recognized in accordance with the user data associated with a biometric signature.

### FIELD OF THE DISCLOSURE

The present disclosure is generally related to speech recognition system interfaces.

### BACKGROUND

Consumer electronics such as computers, cellular phones, personal digital assistants and television set top boxes have become increasingly common. User interfaces for electronic devices continually improve in terms of ease of use and security. For example, automatic speech recognition (ASR) provides viable speech interpretation for portable devices requiring only a limited vocabulary. As another example, distributed speech recognition (DSR) uses a networked device as a front end to a more powerful speech recognition engine in the network. Voice interfaces are therefore becoming increasingly common in portable devices.

However, speech recognition interfaces present various difficulties. In general, high quality speech recognition performance is obtained when a speech recognition system has been trained to an individual speaker. For a shared device that may be used by multiple users, knowledge of the user identity must be provided to the speech recognition system to generate high quality results for each user. Traditional techniques of identifying a user, such as by entering a personal identification number (PIN) via a keypad, tend to be awkward and time-consuming, and frustrate the natural and intuitive device interaction otherwise possible by the voice interface.

### BRIEF DESCRIPTION OF THE DRAWINGS

FIG. 1 is a block diagram illustrating an embodiment of a biometric and speech recognition system;

FIG. 2 is a flow diagram illustrating an embodiment of a method of operation for the system of FIG. 1.

FIG. 3 is a block diagram illustrating a remote control;

FIG. 4 a flow diagram illustrating a speech recognition method;

FIG. 5 is a flow diagram illustrating a method for a set top box; and

FIG. 6 is a block diagram illustrating a general computer system.

### DETAILED DESCRIPTION OF THE DRAWINGS

A remote control device is disclosed and includes a non-voice based biometric detector to detect a biometric signature and a microphone to receive spoken commands. The remote control device also includes a processor and a memory device accessible to the processor. The memory device includes a user recognition module executable by the processor to associate the biometric signature with user data. The memory device also includes a speech recognition engine executable by the processor to recognize the spoken commands in accordance with the user data associated with the biometric signature.

In another embodiment, a remote control device is disclosed and includes a microphone to receive spoken commands. The remote control device also includes a button coupled to the microphone to enable the microphone in response to a user actuation of the button. The remote control device further includes a non-voice based biometric detector located proximate the button to detect a biometric signature of a user concurrently with the actuation of the button.

In another embodiment, a speech recognition method is disclosed and includes detecting by a remote control device a non-voice based biometric signature. The method also includes associating user data stored in a memory of the remote control device with the biometric signature. The method also includes receiving a spoken command from a user of the remote control device. The method also includes recognizing the spoken command using a speech recognition engine executed by the remote control device, the speech recognition engine operating in accordance with the user data.

In another embodiment, a speech recognition method is disclosed and includes detecting, by a remote control device, a user pressing a button. The method also includes concurrently with detecting the user pressing the button, detecting fingerprint data of a fingerprint of a finger pressing the button. The method also includes comparing user data stored in a memory of the remote control device with the fingerprint data. The method also includes, in response to not finding user data in the memory of the remote control device associated with the fingerprint data. The method also includes transmitting the fingerprint data to a remote network device. The method also includes receiving from the network device user profile data associated with the fingerprint data. The method also includes receiving by the remote control device a spoken command while the button is pressed. The method also includes recognizing the spoken command using a speech recognition engine executed by the remote control device, the speech recognition engine operating in accordance with the user profile data received from the set top box.

In another embodiment, a set of processor instructions embedded in a processor-readable medium are disclosed. The set of processor instructions includes instructions to receive a non-voice based biometric signature. The set of processor instructions also includes instructions to associate user data with the non-voice based biometric signature. The set of processor instructions also includes instructions to receive a spoken command. The set of processor instructions also includes instructions to recognize the spoken command using a speech recognition engine in accordance with the user data.

In another embodiment, a method for a set-top box is disclosed and includes receiving from a remote device data comprising user data and data associated with a spoken command. The method also includes sending the received data over a network interface to a network speech recognition engine. The method also includes receiving over the network interface an instruction corresponding to the spoken command. The method also includes processing the instruction corresponding to the spoken command.

In another embodiment, a set of processor instructions embedded in a processor-readable medium is disclosed. The set of processor instructions includes instructions to receive from a remote device data comprising user data and data associated with a spoken command. The set of processor instructions also includes instructions to send the received data over a network interface to a network speech recognition server. The set of processor instructions also includes instructions to receive over the network interface an instruction corresponding to the spoken command. The set of processor instructions also includes instructions to process the instruction corresponding to the spoken command.

In another embodiment, a user profile embedded in a processor-readable medium is disclosed and includes fingerprint data corresponding to a fingerprint scanner of a remote control. The user profile also includes speech recognition data corresponding to speech of the user received by the remote control. The user profile data also includes transaction history data corresponding to transactions of the user with the remote control.

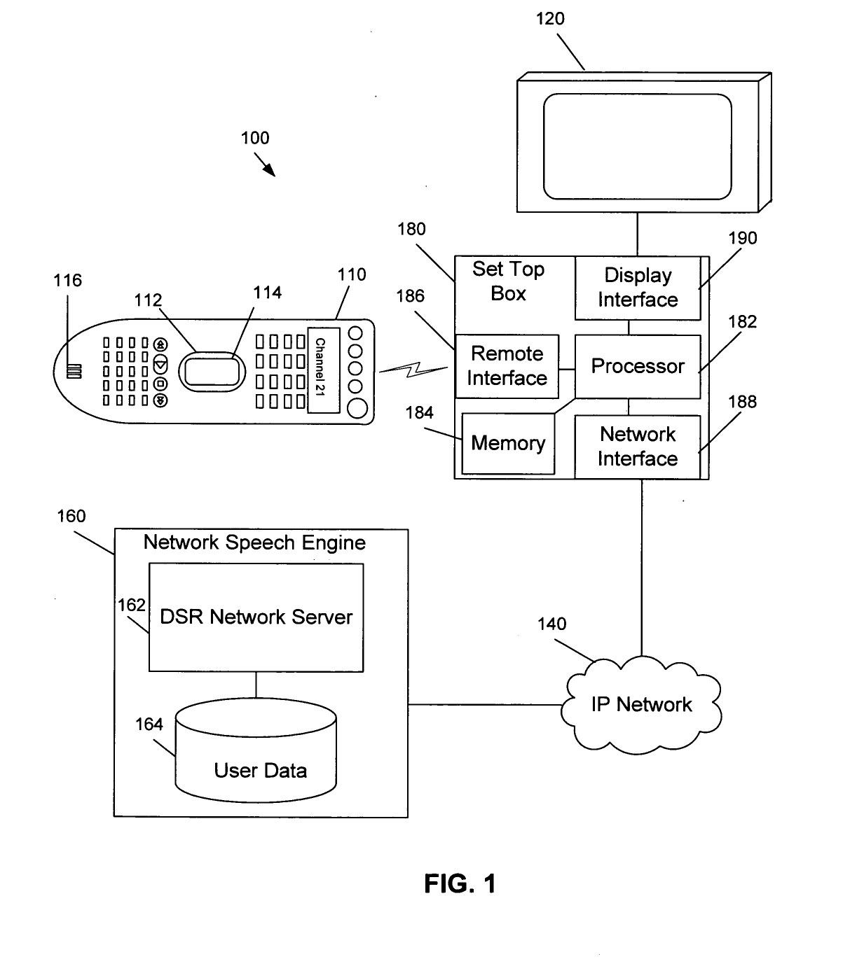

Referring to FIG. 1, an illustrative embodiment of a biometric enabled speech recognition system is shown and generally depicted 100. System 100 includes a remote control device 110 capable of wireless communication with a network device 180. Network device 180 is depicted in FIG. 1 as a set-top box coupled to a display device 120. Network device 180 can communicate with a network speech engine 160 via a network 140.

In the embodiment illustrated in FIG. 1, remote control device 110 can operate in response to a user's voice commands. A button 112 operates a microphone 116 so that only speech detected by microphone 116 while button 112 is pressed will be interpreted as voice commands. A biometric detector 114 that scans fingerprints is positioned on button 112 to detect a user and provide an enhanced interface with system 100.

Set-top box 180 includes a processor 182 and a memory device 184 that is accessible to processor 182. Additionally, processor 182 is coupled to a network interface 188. Further, processor 182 can be coupled to a display interface 190, such as a television interface, through which the set top box 180 can communicate video content or other content to display device 120. Processor 182 can wirelessly communicate with remote control device 110 over remote control interface 186. Set top box 180 may further include well known components for receiving and displaying data as well as engaging in wireless communication with one or more remote devices such as remote control devices 110.

Set top box 180 is coupled to network speech engine 160 via internet protocol (IP) network 140. Network speech engine 160 includes a distributed speech recognition (DSR) network server 162 coupled to a user data store 164. DSR network server 162 receives data relating to spoken commands and executes speech recognition software to recognize the spoken commands.

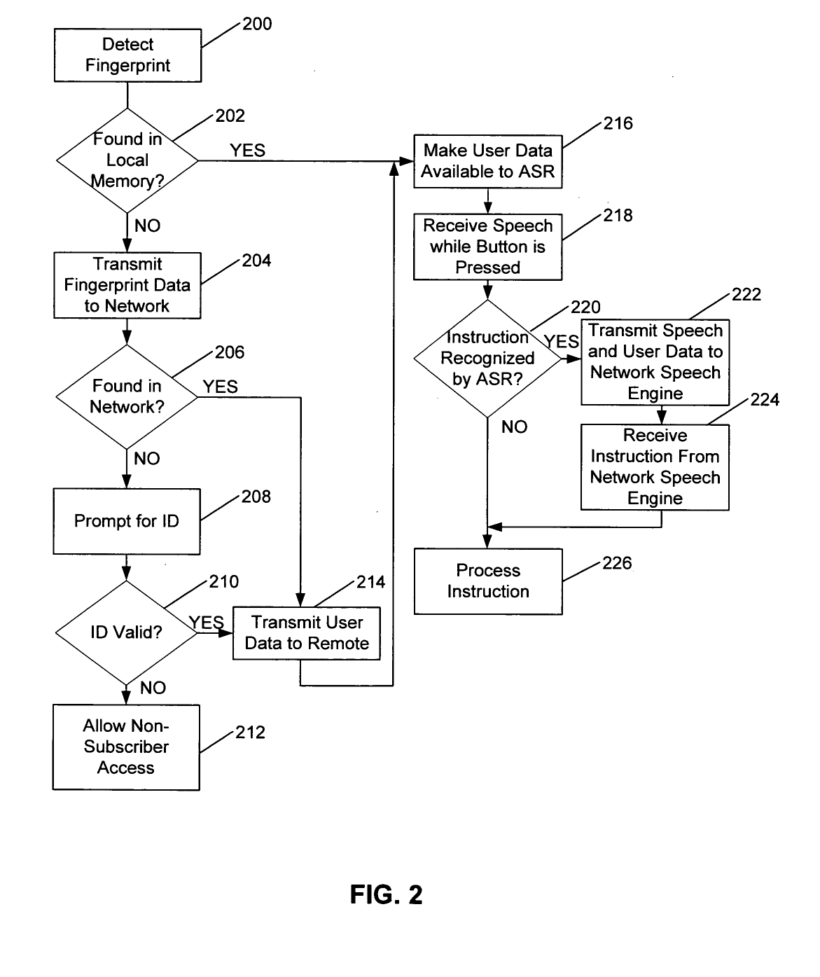

Referring to FIG. 2, an illustrative example of a method of operation of the system 100 is depicted. In block 200, a fingerprint of a user of remote control device 110 is detected by biometric detector 114 located on button 112. At block 202, the fingerprint is compared to user data stored in a memory of the remote control device 110 to identify the user. If user data is found in the memory corresponding to the fingerprint, the method proceeds to block 216.

If the user cannot be identified by the remote control device 110, data corresponding to the fingerprint is transmitted to the network (block 204) for user identification by a system database, such as the user data store 164 of the network speech engine 160. If the user is identified (block 206), user data associated with the fingerprint is transmitted to and stored in the remote control device 110 at block 214. Otherwise, the user is prompted to enter identifying information such as a phone number or account number at block 208. The identifying information is transmitted via the network device 180 and the network 140 to a device maintaining a subscriber list to verify the user is authorized to use the system 100. The subscriber list may be stored as part of the user data 164, or may be stored at a separate device accessible to the network 140. Continuing to block 210, if the user identification information corresponds to a valid user, data associated with the user is transmitted to and stored at the remote control device 110 at block 214. If the user identification information does not correspond to a valid user, the user is granted non-subscriber access to the system 100 at block 212. Access allowed to non-subscribers may depend on the nature of the access desired. For example, a non-subscriber may be allowed to change the volume of the display device 120, but may not be allowed to order special content for viewing.

Proceeding to block 216 from either block 202 or block 214, the user data corresponding to the current user of remote control device 110 is made available to an automatic speech recognition (ASR) engine executed by remote control device 110. At block 218, user speech is received via microphone 116 when button 112 is pressed. The received speech is processed by the ASR engine of the remote control device 110. The ASR engine may use the user data to assist in recognizing an instruction spoken by the user from the received speech. For example, the user data may include a speech module corresponding to the speech of the user. As another example, the user data may include historical transaction data of the user with system 100 or remote control device 110, to assist in recognition of the current command based on past commands.

If the command is not recognized with sufficient confidence by the ASR engine at block 220, data associated with the received speech and the user are transmitted to the network speech engine 160 via the network device 180 and network 140, at block 222. Network speech engine 160 may execute more sophisticated and computationally intensive speech recognition software and may store more comprehensive user data 164 than available to remote control device 110, and may thus be more likely to accurately recognize the command spoken by the user. An instruction corresponding to the recognized command is transmitted to the remote control device 110 via network 140 and network device 180, and the instruction is received at block 224.

Continuing to block 226, the instruction may be processed in accordance with the current user profile. For example, the user data may define levels of access to the system 100 that prohibit the execution of the instruction, such as a child attempting to access adult content. As another example, the instruction may refer to prior transactions, such as “continue playing the last movie I was watching.” As yet another example, the instruction may refer to data that is personal to the user, such as “call Mom,” which would initiate a call to the number associated with the user's mother stored in the user data. As one of ordinary skill in the art will understand, additional queries to the user data store 164 may be performed if data is required that is not available in the user data stored on the remote. One of ordinary skill in the art will also recognize that other devices beyond those shown in FIG. 1 may be included in system 100 and would be accessible via network 140 or other networks to process user instructions and system functions.

From a user's perspective, the interface to system 100 is efficient, natural, and intuitive: the user may simply press a button on a shared device and speak a command. Because remote control device 110 performs both fingerprint recognition and speech recognition, transactions may be performed without requiring access to network resources. Responses may thus be faster than if network access were required and network resources are conserved. Further, because speech recognition is performed in the context of the user data, information and transactions customized to the individual user may be searched and compared to increase the efficiency, accuracy, or confidence level of the speech recognition operation.

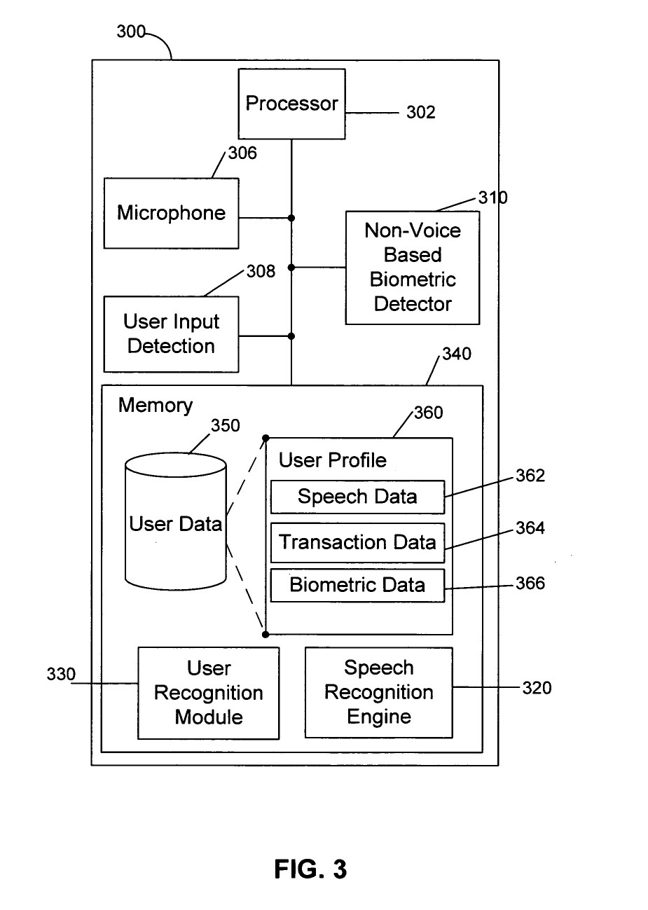

With reference to FIG. 3, a block diagram of a biometric enabled remote control device 300 is depicted. The remote control device 300 includes a non-voice based biometric detector 310 capable of detecting a non-voice based biometric signature, a button actuation detection unit 308 that detects user input of a button actuation, and a microphone 306 to receive spoken commands. The non-voice based biometric detector 310, button actuation detection 308, and microphone 306 are coupled to a memory device 340 which is further coupled to and accessible to a processor 302. Those of ordinary skill in the art will recognize that the remote control device 300 includes additional components, such as transceivers and the like, to carry out wireless communications. The remote control device 300 may also include components such as a keypad or a display generally associated with a remote control.

In some embodiments, the button actuation detection unit 308 responds to a button which is located proximate to the biometric detector 310, so that the biometric detector 310 may detect a biometric signature concurrently with an actuation of the button. The biometric detector 310 may be any device that can electronically read or scan a non-voice based biometric signature, such as a fingerprint pattern, handprint pattern, retinal pattern, genetic characteristic, olfactory characteristic, or the like, or any combination thereof, as non-limiting, illustrative examples. For example, in particular embodiments where the button actuation detection unit 308 detects pressing of a biased push-button, the biometric detector 310 may be a fingerprint scanner located on or within the biased push-button to scan a finger pressing surface of the button.

Microphone 306 may be responsive to the button actuation detection unit 308, such that button actuation toggles the microphone 306 on and off. One advantage to the resulting “push-to-talk” operation is that ambient noise and speech not intended as commands for the remote control device 300 are not processed, thus reducing processing requirements and potential mistakes in recognizing voice commands.

The remote control device 300 stores user data 350 in memory 340. User data 350 may include for each user of the remote control device 300 a user profile 360 associating speech recognition data 362 corresponding to speech received by remote control device 300, transaction data 364 corresponding to transactions with the remote control, and biometric data 366 corresponding to the user's biometric characteristics. Additional data such as the user's name, account number, preferences, security settings and the like may also be stored as user data 350 included with user profile 360.

The remote control device 300 includes a user recognition module 330 executable by the processor 302 to associate the biometric signature with the user data 350. User recognition module 330 receives data from the non-voice based biometric detector 310 corresponding to a biometric signature and locates biometric data 366 in the user data 350 corresponding to the biometric signature of the current user, along with the user profile 360 associated with the current user.

Remote control device 300 further includes a speech recognition engine 320 executable by the processor 302 to recognize spoken commands received by the microphone 306. Speech recognition module 320 receives as an input a signal generated by the microphone 306 corresponding to spoken commands. The spoken commands are interpreted from the input signal and a confidence level is assigned to the interpretation.

In some embodiments, the speech recognition engine 320 operates in accordance with the user data 350. The speech recognition engine 320 can receive speech recognition data associated with the biometric signature in the form of speech data 362 from the user profile 360 corresponding to the current user. Speech data 362 can represent user voice characteristics obtained from prior user transactions with the remote control device 300 or obtained by other methods, such as downloaded from network speech engine 160 via network 140 and the set top box 180 (See FIG. 1), as an illustrative example.

In some embodiments, speech recognition engine 320 can receive a history of transactions associated with the biometric signature in the form of transaction data 364 from the user profile 360 corresponding to the current user. Transaction data 364 may include frequently spoken commands and other historical preferences associated with the user from past transactions. Transaction data 364 can include data from past transactions of the current user with the remote control device 300, or from past transactions of the current user with other remotes or devices associated with system 100, or both. Transaction data from other remotes or devices may be downloaded to memory 340 via a wireless network connection or via a data port (not shown), as illustrative examples. Speech recognition engine 320 may operate in accordance with the transaction data 364; for example, speech recognition engine 320 may assign a higher confidence level to recognized commands frequently found in transaction data 364.

Furthermore, although in some embodiments the microphone 306 is depicted as responsive to the button actuation detection 308 by toggling on and off, one of ordinary skill in the art will recognize other methods by which the microphone 306 may be responsive to an input. As illustrative examples, microphone 306 may toggle between a high-gain and low-gain condition in response to button actuation detection 308, or a signal generated by microphone 306 may not be transmitted to or acted on by the processor 302 until the button is actuated.

Still further, although in some embodiments the button 308 operates as a biased switch enabling operation of the microphone 306 only while the button 308 is pressed, one of ordinary skill in the art will recognize that the button 308 need not be a biased push button and may instead be any control element that may be actuated or manipulated by a user of the remote control device 300 to control an operation of the microphone 306. As illustrative, non-limiting examples, the button 308 may be a rocker switch, toggle switch, mercury switch, inertial switch, pressure sensor, temperature sensor, or the like. Furthermore, button 308 may also control other components in addition to the microphone 306. As an example, pressing the button 308 may also cause the remote control device 300 to transmit a “mute” command so that ambient noise is reduced while commands are spoken.

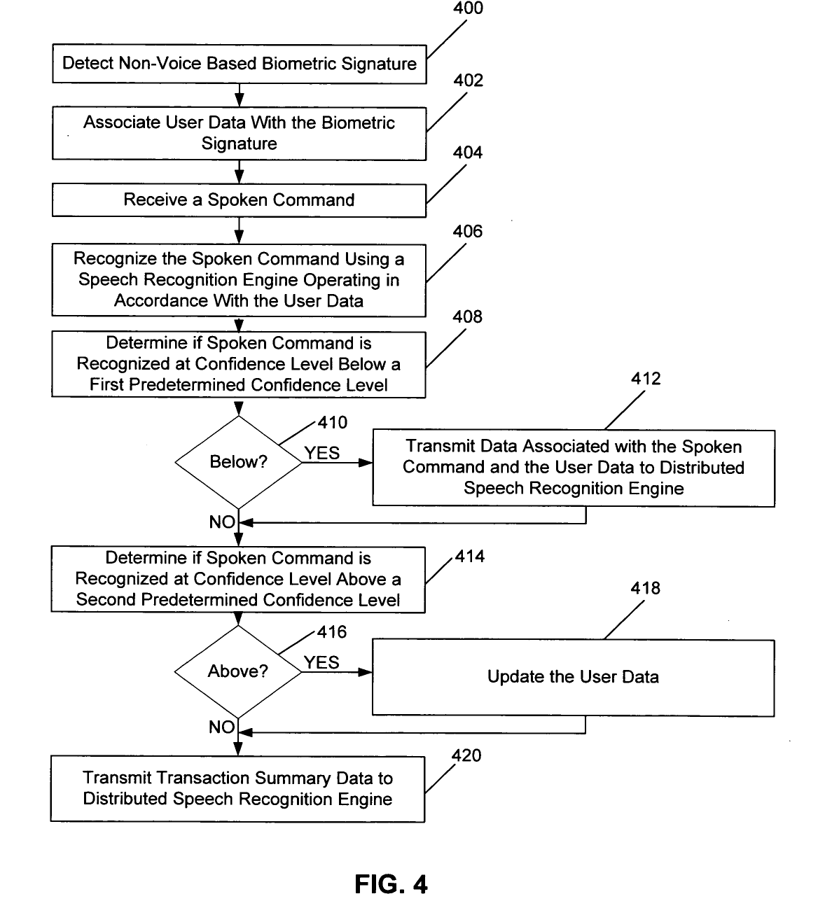

Referring to FIG. 4, a speech recognition method is shown and begins with block 400. At block 400, a non-voice based biometric signature is detected. Moving to block 402, user data is associated with the biometric signature. Continuing to block 404, a spoken command is received. At block 406, the spoken command is recognized by a speech recognition engine operating in accordance with the user data.

The method depicted in FIG. 4 enables a device with a voice interface to efficiently identify a user via a non-voice based biometric detector. For example, a user may be identified via fingerprint, handprint, DNA, retinal characteristics, or any other type of non-voice based biometric activity as a result of normal interactions with the device. As an illustrative example, the hand print of a cell phone user may be read as the user is dialing the phone or holding it to an ear. As another illustrative example, user retinal characteristics may be detected as a user reads a display on a PDA. The user therefore is not required to enter a PIN or take any other action that would delay or hinder normal device operation.

In an illustrative, non-limiting embodiment, the method of FIG. 4 may be practiced on a remote having a biometric detector and a microphone such as the remote control device 300 depicted in FIG. 3. A biometric signature is detected, such as a fingerprint of a user of a remote control. In response to detecting the biometric signature, user data stored in a memory device of the remote is compared to the biometric signature to identify a user by matching the biometric signature to previously stored biometric data of the user.

In particular embodiments, the spoken command is received via a microphone that is enabled in response to a user input. In an illustrative embodiment, the user input is a user actuation of a button, and the biometric signature is detected concurrently with receiving the user input. As a non-limiting example, the biometric signature may be a fingerprint detected by a fingerprint detector located on a pushbutton that turns on a microphone. Pressing the button results in detecting the biometric signature and turning on the microphone concurrently.

In some embodiments, a confidence level is assigned to the recognition of a spoken command. In a particular embodiment, data associated with the spoken command and the user data is transmitted to a distributed speech recognition engine in response to recognizing the spoken command at a confidence level below a first predetermined confidence level as depicted in optional blocks 408, 410 and 412. Using the system of FIG. 1 as a non-limiting, illustrative example, the remote control device 110 may include an automatic speech recognition (ASR) engine to recognize spoken commands. If a spoken command is not recognized by the ASR engine above a first predetermined confidence level, data associated with the spoken command as well as data associated with the user, such as a user identification number, may be transmitted to the network speech engine 160 via the set top box 180 and the network 140. Network speech engine 160 may provide a more accurate recognition than the ASR engine, for example, because of increased processing power for performing more computationally intensive speech recognition algorithms. Recognition results from the network speech engine 160 may be directed to an appropriate destination within the system 100 for processing the user command.

In a particular embodiment, the user data is updated in response to recognizing the spoken command at a confidence level above a second predetermined confidence level, as depicted in optional blocks 414, 416 and 418. As one example, a successful interpretation of a spoken command may be used to train or refine speech recognition data associated with the user. As another example, the spoken command may be recorded in a transaction history associated with the user.

In another particular embodiment, transaction summary data is transmitted to a distributed speech recognition engine as depicted in optional block 420. The transaction summary data includes user identification data and at least one of a transaction history and speech recognition data associated with the user. Referring to the system 100 of FIG. 1 for an illustrative example, after a user interacts with the remote control device 110, the remote control device 110 transfers data to the network speech engine 160 via the set top box 180 and the network 140. The data transmitted may contain updated speech recognition files resulting from the interaction, or may contain a list of spoken commands or transactions implemented by the user, or any combination thereof. The network speech engine 160 stores the received data in the user data store 164.

A remote control device may also be shared by a second user. In a particular embodiment, the speech recognition method further includes detecting by the remote control device a second non-voice based biometric signature. Second user data stored in the memory of the remote control device is associated with the second biometric signature. The remote control device receives a second spoken command from a second user of the remote control device. The second spoken command is recognized using the speech recognition engine executed by the remote control device, where the speech recognition engine operates in accordance with the second user data.

Although the system 100 of FIG. 1 depicts a single remote control device 110 communicating with a single network device 180, in practice a user may interact with multiple devices using the network speech engine 160 in a distributed speech recognition system. For example, a user may regularly interact with a cell phone, television remote, automobile and laptop computer each having a biometric detector and a speech recognition engine front end in communication with the network speech engine 160. The network speech engine 160 may therefore synchronize user data 164 between shared user devices. For example, after a user requests from a laptop computer reservations and a map for a specific hotel via a voice interface, the laptop may send to the network speech engine 160 user data associated with the transaction. The network speech engine may then forward the updated user data to all devices regularly used by the user. When the user commands a cell phone via a voice interface to call the hotel, the cell phone speech recognition engine may assign a higher confidence level to recognizing the hotel name as a result of the user's prior interaction with the laptop computer.

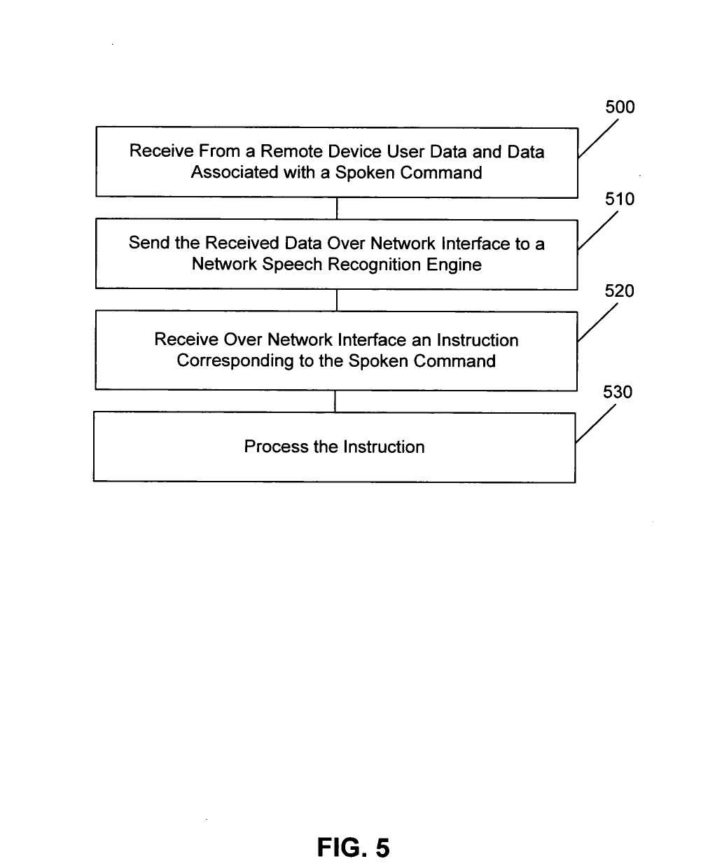

Referring to FIG. 5, an embodiment of a method for operation of a network device, such as set-top box 180 of FIG. 1, is illustrated. At block 500, user data and data associated with a spoken command is received from a remote device. Continuing to block 510, the received data is sent to a network speech recognition engine. At block 520, an instruction corresponding to the spoken command is received from the network speech recognition engine. At block 530, the instruction is processed.

In an illustrative embodiment, the method may be performed by the set top box 180 of the system 100 depicted in FIG. 1. The set top box 180 may receive a user identification number and encoded compressed spectral parameters from a user's speech from a remote control device 110 having a distributed speech recognition front end. This may occur for example in response to an ASR engine in the remote control device 110 being unable to recognize a spoken command above a first confidence level. The data received by the set top box 180 via the remote interface 186 is sent via the network 140 to the network speech recognition engine 160. The data transmitted by the set top box 180 may be compressed or reformatted prior to transmission. For example, the data may be formatted for IP transmission over the network 140.

The set top box receives from the network speech recognition engine 160 an instruction corresponding to the spoken command via the network 140, and processes the instruction. For example, if the original command was “view channel ten,” the set top box 180 may receive from the network speech recognition engine 160 an instruction directing the set top box 180 to display the video content relating to channel ten onto the display device 120. The set top box 180 may then process the instruction to display channel ten on the display device 120. As another example, if the spoken command is directed to a function performed by another device, such as remote control device 110 or display 120, the set top box 180 may process the instruction by simply forwarding the instruction to the appropriate device.

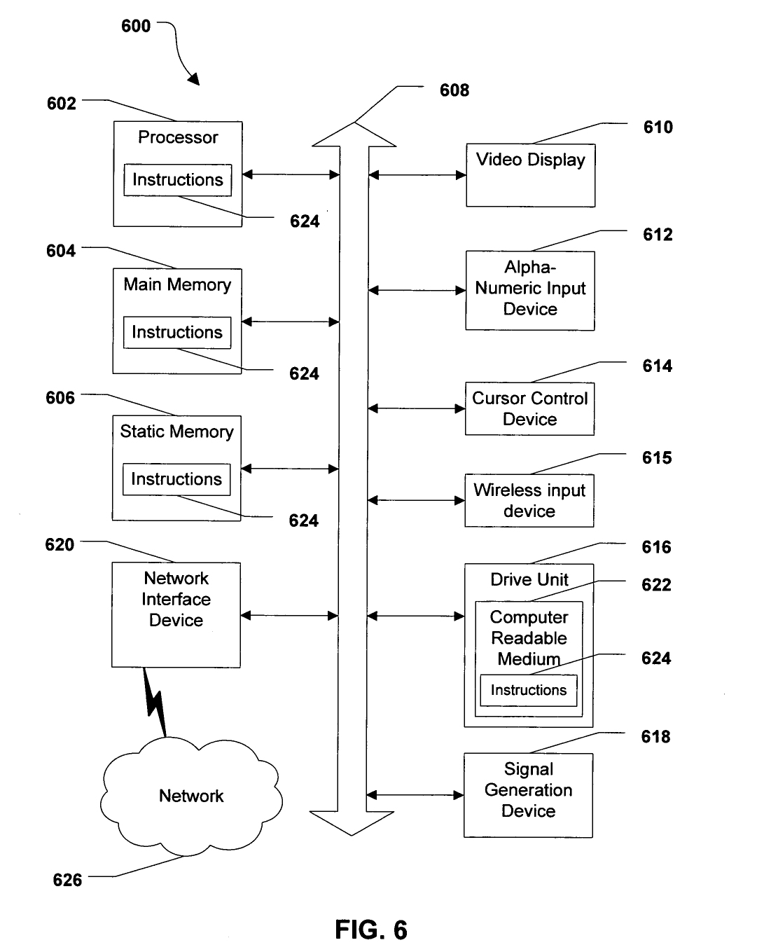

Referring to FIG. 6, an illustrative embodiment of a general computer system is shown and is designated 600. The computer system 600 can include a set of instructions that can be executed to cause the computer system 600 to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. Moreover, the computer system 600 can include a main memory 604 and a static memory 606, that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, and a cursor control device 614, such as a mouse. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A remote control device comprising:
a non-voice based biometric detector to detect a biometric signature;
a microphone to receive spoken commands; and
a processor and a memory device accessible to the processor, wherein the memory device includes:
a user recognition module executable by the processor to associate the biometric signature with user data; and
a speech recognition engine executable by the processor to recognize the spoken commands in accordance with the user data associated with the biometric signature.

2. The device of claim 1, wherein the user data comprises a history of transactions associated with the biometric signature.

3. The device of claim 1, wherein the user data comprises speech recognition data associated with the biometric signature.

4. The device of claim 1, further comprising a button proximate the biometric detector to detect the biometric signature concurrently with actuation of the button, and wherein the microphone is responsive to actuation of the button.

5. The device of claim 1, wherein the speech recognition engine comprises an automatic speech recognition engine.

6. The device of claim 5, wherein the speech recognition engine further comprises a portion of a distributed speech recognition engine.

7. A remote control device comprising:
a microphone to receive spoken commands;
a button coupled to the microphone to enable the microphone in response to a user actuation of the button; and
a non-voice based biometric detector located proximate the button to detect a biometric signature of a user concurrently with the actuation of the button.

8. The device of claim 7, wherein the button is a biased push button.

9. The device of claim 8, further comprising a processor and a memory device accessible to the processor, wherein the memory device includes:
a user recognition module executable by the processor to associate the biometric signature with user data; and
a speech recognition engine executable by the processor to recognize spoken commands in accordance with the user profile data associated with the biometric signature.

10. The device of claim 9, wherein the user profile includes biometric data, transaction data, and speech recognition data.

11. A speech recognition method comprising:
detecting by a remote control device a non-voice based biometric signature;
associating user data stored in a memory of the remote control device with the biometric signature;
receiving a spoken command from a user of the remote control device; and
recognizing the spoken command using a speech recognition engine executed by the remote control device, the speech recognition engine operating in accordance with the user data.

12. The method of claim 11, wherein the spoken command is received concurrently with receiving a user input.

13. The method of claim 12, wherein the user input is actuation of a button, and wherein the biometric signature is detected concurrently with receiving the user input.

14. The method of claim 13, wherein the biometric detector is a fingerprint detector located proximate the button to detect a fingerprint in contact with the button.

15. The method of claim 11, further comprising transmitting data associated with the spoken command and the user data to a distributed speech recognition engine in response to recognizing the spoken command at a confidence level below a first predetermined confidence level.

16. The method of claim 11, further comprising updating the user data in response to recognizing the spoken command at a confidence level above a second predetermined confidence level.

17. The method of claim 11, further comprising transmitting transaction summary data to a distributed speech recognition engine, the transaction summary data comprising user identification data, a transaction history associated with the user, and speech recognition data associated with the user.

18. The method of claim 11, further comprising:
comparing user data stored in the memory of the remote control device with the non-voice based biometric signature;
transmitting data corresponding to the non-voice based biometric signature to a remote network device in response to not locating in the memory of the remote control device user data associated with the biometric signature;
receiving user profile data associated with the non-voice based biometric signature; and
storing the received user profile data in the memory of the remote control device.

19. The method of claim 11, further comprising:
detecting by the remote control device a non-voice based second biometric signature;
associating by the remote control device second user data stored in the memory of the remote control device with the second biometric signature;
receiving by the remote control device a second spoken command from a second user of the remote control device; and
recognizing the second spoken command using the speech recognition engine executed by the remote control device, the speech recognition engine operating in accordance with the second user data.

20. A speech recognition method comprising:
detecting, by a remote control device, a user pressing a button;
concurrently with detecting the user pressing the button, detecting fingerprint data of a fingerprint of a finger pressing the button;
comparing user data stored in a memory of the remote control device with the fingerprint data;
in response to not finding user data in the memory of the remote control device associated with the fingerprint data, transmitting the fingerprint data to a remote network device;
receiving from the remote network device user profile data associated with the fingerprint data;
receiving by the remote control device a spoken command while the button is pressed; and
recognizing the spoken command using a speech recognition engine executed by the remote control device, the speech recognition engine operating in accordance with the received user profile data.

21. The method of claim 20, further comprising transmitting data associated with the spoken command and the user profile data to the remote network device in response to recognizing the spoken command at a confidence level below a first predetermined confidence level.

22. A set of processor instructions embedded in a processor-readable medium, the processor instructions comprising:
instructions to receive a non-voice based biometric signature;
instructions to associate user data with the non-voice based biometric signature;
instructions to receive a spoken command; and
instructions to recognize the spoken command using a speech recognition engine in accordance with the user data.

23. A method for a set-top box, comprising:
receiving from a remote device data comprising user data and data associated with a spoken command;
sending the received data over a network interface to a network speech recognition engine;
receiving over the network interface an instruction corresponding to the spoken command; and
processing the instruction corresponding to the spoken command.

24. The method of claim 23, wherein the network interface includes an internet protocol network.

25. A set of processor instructions embedded in a processor-readable medium, the processor instructions comprising:
instructions to receive from a remote device data comprising user data and data associated with a spoken command;
instructions to send the received data over a network interface to a network speech recognition server;
instructions to receive over the network interface an instruction corresponding to the spoken command; and
instructions to process the instruction corresponding to the spoken command.

26. A user profile embedded in a processor-readable medium, comprising:
fingerprint data corresponding to a fingerprint scanner of a remote control;
speech recognition data corresponding to speech of the user received by the remote control; and
transaction history data corresponding to transactions of the user with the remote control.

27. The user profile of claim 26, wherein the transaction history data includes data corresponding to a spoken command recognized at a confidence level above a predetermined confidence level.

28. The user profile of claim 26, wherein the transaction history data includes data corresponding to a spoken command recognized by a first wireless device and further includes data corresponding to a spoken command recognized by a network speech engine.

29. The user profile of claim 28, wherein the first wireless device is the remote control, and wherein the transaction history data further includes data corresponding to a spoken command recognized by a second wireless device.

30. The user profile of claim 26, wherein the transaction history data comprises a command from a user associated with the user profile.

31. The user profile of claim 27, wherein the command is a spoken command recognized by the remote control.
